(19) United States
(12) Patent Application Publication
(10) Pub. No.: US 2006/0244625 A1
(43) Pub. Date: Nov. 2, 2006

(54) Device, controller, method and signal for remote control

(76) Inventors: Gunter Verdickt, Roosdaal (BE); Kenneth Kwek, Singapore (SG); Weng Lam, Singapore (SG)

Correspondence Address: PHILIPS INTELLECTUAL PROPERTY & STANDARDS, P.O. BOX 3001, BRIARCLIFF MANOR, NY, 10510, US

(21) Appl. No.: 10/550,334

(22) PCT Filed: Mar. 22, 2004
(86) PCT No.: PCT/IB04/50298

§ 371 Date: Sep. 22, 2005

(30) Foreign Application Priority Data
Mar. 27, 2003 (SG) SG03/00085

(51) Int. Cl. G05B 19/02

(52) U.S. Cl. 340/825.22; 341/176; 340/825.69

(57) ABSTRACT

Remotely controlling a device still has several inconveniences associated with it, like the plurality of dedicated controllers, the hassle of learning or programming a remote controller, a preprogrammed memory bank which is outdated, the distribution and sharing of programs, or separate efforts to design the receiver of the device and the transmitter of the controller. To solve these inconveniences, the device is equipped with transmitting means for transmission of its properties that explicitly define how the device can be remotely controlled. The remote controller is equipped with receiving means for the properties and subsequently uses the properties for remotely controlling the device, by generating and transmitting signals in accordance with the properties.

The invention relates to a device being remotely controllable by means of a signal, the device having a property which defines at least partially how the device is remotely controllable.

The invention also relates to a controller for remotely controlling a device by generating a signal and transmitting the signal to the device.

The invention also relates to a system comprising a device being remotely controllable by means of a signal, and a controller for remotely controlling the device by generating and transmitting the signal.

The invention also relates to a method of remotely controlling a device by means of a signal.

The invention also relates to a signal for transmitting a property of a remotely controllable device.

The invention also relates to a signal for initiating a transmission of a property of a remotely controllable device.

An embodiment of the device described in the opening paragraph is known from U.S. Pat. No. 6,157,316, which discloses a device that can be controlled from a remote controller, as discussed further below.

Remotely controllable devices and their respective controllers are ubiquitous nowadays. Such devices are usually each shipped and sold with a dedicated controller for the brand and model of that particular device. One drawback is that operating several of these devices involves operating many controllers. Another drawback is that, as described below, a device may be controlled from a so-called universal remote controller, leaving the dedicated controller unused, thus wasting resources and incurring unnecessary costs.

The well-known learnable remote controllers alleviate this hassle, because they are able to receive, store and retransmit the signals transmitted by dedicated controllers. A single learnable remote controller can transmit the signals of a number of dedicated controllers, serving as a single replacement for the latter. A drawback of the learnable remote controller is, however, that ‘teaching’ it is a rather cumbersome process in itself. It requires putting the dedicated controller vis à vis the learnable controller and pushing several buttons for each stored signal, explicitly programming each desired function of the learnable controller.

The equally well-known universal remote controllers alleviate the hassle of programming the learnable controller by carrying a preprogrammed memory bank containing signals for many devices. By entering an index number that is associated with the brand and model of the device, the universal controller is programmed for the device (see U.S. Pat. No. 5,872,562). Another approach is to derive the brand and the model of the device by capturing a signal from the dedicated controller (WO98/00933). The universal remote controller has the drawback that a fixed memory bank is of no use for later devices that were not anticipated when the controller was made.

The method disclosed in U.S. Pat. No. 6,157,316 also involves a universal remote controller with a fixed memory bank. Rather than looking up and entering the index number, it is described how the device, at first-time use, powers up in a special mode, periodically transmitting the index number to be received by a universal remote controller. Upon reception of the index number, the controller commands the device to stop transmitting and it programs itself as a dedicated controller for the device by looking up the index number in its memory bank. One drawback of this approach is the risk that the fixed memory bank is out-of-date with the device. Another drawback is the partially duplicate efforts required to maintain the memory bank and develop devices.

Another known improvement of the universal remote controller entails uploading and downloading its program or parts thereof from the Internet (WO01/39150A3). This allows the exchange of (parts of) programs that address also the devices of the latest brand and model. One drawback of this is the cumbersome creation and distribution of the exchanged programs.

It is an object of the present invention to provide a device and a remote controller of the kind described in the opening paragraphs, which alleviate at least some of the above-mentioned drawbacks.

To this end, one aspect of the invention provides a device that is characterized in that it comprises:
transmitting means for transmitting the property to a remote controller for generating the signal in dependence on the property; and
receiving means for receiving the signal.

By enabling the device to transmit explicit properties on how it can be remotely controlled, the device becomes the authoritative source of this information. In effect, the device itself is now capable of “programming” the remote controller. This ensures that the information is up-to-date with the device. Since the device carries the information on how to control it, the device may be shipped and sold without dedicated controller, presuming the end-user already has a remote controller according to the invention. Also in the case of a lost or defective dedicated controller, the device may still be remotely controlled from a universal remote controller by transmitting its properties. Finally, there is neither a need for the maintenance nor for the distribution of memory banks or (parts of) programs.

In an embodiment of the device according to the invention, the property at least partially defines the signal. By transmitting an explicit property of the signal, the device simplifies generating the signal by the remote controller.

In an embodiment of the device according to the invention, the device comprises processing means for processing the received signal in dependence on a code, and the property at least partially defines the code. The remote controller can subsequently generate the signal in accordance with the code and can avoid transmitting an unsupported coded signal.

In an embodiment of the device according to the invention, the device is remotely controllable by means of a further signal and is arranged to transmit the property in response to receiving the further signal. This enables the remote controller to interrogate the device for its characteristics.

Another aspect of the invention provides a controller that is characterized in that it comprises receiving means for receiving a property of the device transmitted by the device, the property at least partially defining how the device is remotely controllable, and the controller being arranged to generate the signal in dependence on the received property.

In an embodiment of the controller according to the invention, the controller is arranged to generate and transmit a further signal for commanding the device to transmit the property. This enables the remote controller to interrogate the device for its characteristics. It also simplifies “programming” a single remote controller for multiple devices.

In an embodiment of the controller according to the invention,
the controller has a control for remotely controlling the remotely controllable device;
the signal is generated and transmitted in response to activating the control;
the controller comprises a display screen for displaying the control; and
the property at least partially defines the control. This enables the device to influence how its functions and capabilities are rendered on the remote controller.

The above objects and features of the present invention will be more apparent from the following description of preferred embodiments with reference to the drawing wherein

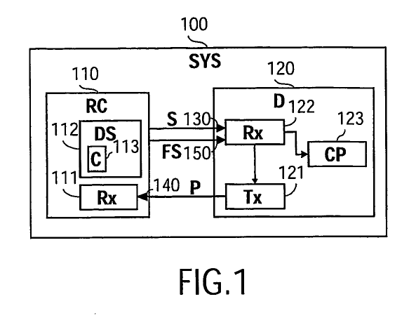

FIG. 1 shows a block diagram of an embodiment of a system according to the invention.

Some of the features indicated in the drawing may be implemented in software, and as such represent software entities, such as software modules or objects.

FIG. 1 shows a block diagram of an embodiment of a system 100 according to the invention, comprising a remote controller 110 and a remotely controllable device 120.

The device 120 is typically an audio and/or video device such as a television, set-top box or audio set. It may be suited for the reception of audio and/or video signals broadcast via a medium like the air, cable, or the Internet. The device 120 may be suited for the reproduction of audio and/or video from storage media like tape, memory, CD, DVD and the like.

Alternatively, the device 120 may be a more exotic device as applied in ambient intelligence like a thermostat, a light-generating device, curtains or a sun screen and the like.

The device 120 is controllable by means of a signal 130 that is generated and transmitted by the controller 110. The signal 130 may be a sound signal (for example, at ultrasonic frequencies) or an electromagnetic signal, including radio signals, (invisible or visible) light signals, and, for example, an infrared signal. A medium like air, fiber, cables and the like can carry the signal 130. The device 120 comprises receiving means 122 that are able to receive the signal 130. The device 120 has certain remotely controllable capabilities (not shown). These capabilities include those typically found in audio devices and video devices, like reproducing audio and/or video from received broadcasts or from a storage medium. Typical remotely controllable capabilities or functions include, for example, play, fast forward/reverse, pause, volume up/down, channel up/down. The device is remotely controllable in the sense that, upon reception of the signal 130, the device activates the capability or function that is associated with that particular signal 130.

The device 120 comprises transmitting means 121 for transmitting a property 140 of the device 120. The property (at least partially) defines how the device 120 is remotely controllable. The property 140 is received by receiving means 111 of the controller 110 and is subsequently used for generating the signal 130. This may comprise several processing steps, like demodulation, decoding, correcting errors, parsing and storing the property in a memory (not shown) of the remote controller 110. Generation of the signal may also comprise steps like generating a carrier frequency, modulating, mixing, encoding, translating and synthesizing in general. The whole procedure effectively provides the remote controller 110 with the explicit recipe to generate the signal 130 and optionally a further signal 150.

The device 120 may transmit several properties 140 sequentially, or combine multiple device properties in a single transmission.

One example of the property 140 is the particularities of the signal 130, like its carrier frequency, modulation scheme, or code set. The signal 130 may be based on a code and the device 120 may comprise code processing means 123 in that case. The code processing means 123 may process the signal 130 received to obtain a command for the device 120.

Another example of the property 140 is the particularities of the remotely controllable capabilities or functions of the device 120, like the supported command set or code set, the mapping between a particular code and the associated function, the supported interface formats, the configuration of the device, the implemented device behavior and its semantics in general.

To allow re-use of components, the transmitting means 121 of the device 120 may comprise the same components (not shown) as used in remote controllers in general. To further facilitate re-use, the transmitting means of the device 120 may utilize the same or substantially similar wavelengths, carrier frequencies, modulation schemes, encoding schemes, command codes and command semantics that are generally used for the signals transmitted by a remote controller for controlling a device.

In order to make the property 140 independent of the specifics of the receiving controller 110, the property 140 can be self-describing or explicit.

For initiating the transmission of the property 140, the device may comprise a button or a control. The transmission may also be initiated by selecting a particular capability in the user interface of the device 120, for example, by using an On Screen Display (OSD) (not shown) of the device 140. Advantageously, the property 140 includes a capability of the device 120 that is not normally available from the dedicated controller that ships with the device 120. This may facilitate the rapid market penetration of devices 120 and remote controllers 110 according to the invention.

To be suited for different remote controllers 110, the properties 140 may be transmitted in a self-contained format, for example, based on a markup language such as XML. In such a format, the semantics of the property 140 can be made explicit by including meta-information.

To save on the required bandwidth for the transmission, and to reduce the response time for programming the controller 110, the properties 140 may be transmitted in a compressed format.

Advantageously, the particularities of the transmission of the property 140 are standardized in such a way that a complying remote controller 110 can remotely control any complying device 120 after transfer of its properties 140.

Advantageously, the properties 140 of the signal 130 may pertain to its wavelength, carrier frequency, modulation, encoding. After reception and processing at the controller 110, these properties 140 can be applied for generating the signal 130. This may involve the use of a general-purpose processor (not shown) with appropriate software.

The properties 140 of the code may pertain to the control command set, the semantics of the control command, or the supported remote control standard (RC-5, RC-6).

To initiate the transmission of the property 140, the remote controller 110 can send a further signal 150. The particularities of the further signal 150 are advantageously standardized in such a way that a complying remote controller 110 can initiate the transmission from any complying device 120. If standardization fails and multiple distinct further signals 150 coexist, the controller 110 may transmit each of the distinct further signals 150 sequentially, attempting to initiate a transmission from the device.

To prevent misuse of effectively gaining remote control over the device 120 by sending the further signal 150 from a second remote controller 110 operated by a malicious user, the device may postpone transmission of properties until a button on the device is pushed. Thus physical access to the device 120 becomes a necessity for gaining control. Another alternative way of preventing misuse is that a unique identification of the remote controller 110 may be comprised in the further signal 150. The device 120 may store this identification in its memory, and may subsequently refuse further signals 150 transmitted from other remote controllers 110. The stored identification may only be released, for example, with a procedure requiring physical access to the device 120. This may ensure that there is at most one remote controller 110 using the properties 140 of the device 120.

The particularities of the transmission of the property 140 may be standardized in such a way that a complying remote controller 110 can effectively control any complying device 120.

Advantageously, the controller 110 may perform a handshake with the device 120 to ensure proper reception of the further signal 150 by the device 120. The handshake can be implemented by having the controller 110, after transmitting the further signal 150, to wait for the property 140 of the device 120, and when the controller 110 fails to receive the property 140, having the controller 110 restart the transmission of the further signal 150.

In one embodiment of the controller according to the invention, the controller 110 comprises a display screen 112. Instead of the common fixed physical buttons on dedicated remote controllers, the display screen 112 may be used for displaying a control 113 that serves as a button. When the control 113 is activated, the controller 110 thus generates and transmits the signal 130 for activating an associated capability or function of the device 120.

In another embodiment of the controller according to the invention, the display screen 112 may be a touch screen where tapping on the display screen 112, substantially at the position of a displayed control 113, activates this control 113.

The property 140 of the control 113 may comprise the geometry, the shape, the bitmap, the colors, the actions or any other attributes of the control 113.

The device 120 may effectively render its remotely controlled capabilities on the display screen 112 of the controller 110 by transmitting properties 140 for a plurality of controls 113.

The controller 110 may determine the layout of the controls 113 on the display screen 112, in response to the received properties 140 of the controls 113.

Advantageously, the property may comprise a unique address of the device (e.g. a serial number assigned by the manufacturer), thus enabling the remote controller to address signals to that particular device. This is especially useful if two or more devices share their brand and model. In such a case, the remote controller 110 may render the controls 113 for each of these devices 120 on the display screen 112 simultaneously, while grouping the controls 113 per device 120.

It is noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. Use of the indefinite article “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A device (120) being remotely controllable by means of a signal (130), the device (120) having a property (140) which defines at least partially how the device (120) is remotely controllable, the device (120) comprising:
transmitting means (121) for transmitting the property (140) to a remote controller (110) for generating the signal (130) in dependence on the property (140); and
receiving means (111) for receiving the signal (130).

2. A device as claimed in claim 1, characterized in that the property (140) at least partially defines the signal (130).

3. A device as claimed in claim 2, characterized in that:
the device (120) comprises processing means (123) for processing the received signal in dependence on a code, and in that
the property (140) at least partially defines the code.

4. A device as claimed in claim 1, characterized in that the device (120) is remotely controllable by means of a further signal (150) and is arranged to transmit the property (140) in response to receiving the further signal (150).

5. A controller (110) for remotely controlling a device by generating a signal (130) and transmitting the signal (130) to the device (120), the controller (110) comprising receiving means (111) for receiving a property (140) of the device (120) transmitted by the device (120), the property (140) at least partially defining how the device (120) is remotely controllable, the controller (110) being arranged to generate the signal (130) in dependence on the received property (140).

6. A controller (110) as claimed in claim 5, characterized in that the controller (110) is arranged to generate and transmit a further signal (150) for commanding the device (120) to transmit the property (140).

7. A controller (110) as claimed in claim 6, characterized in that the property (140) at least partially defines the signal (130).

8. A controller (110) as claimed in claim 7, characterized in that
the controller (110) is arranged to use a code for generating the signal (130); and in that
the property (140) at least partially defines the code.

9. A controller (110) as claimed in claim 6, characterized in that
the controller (110) has a control (113) for remotely controlling the remotely controllable device (120);
the signal (130) is generated and transmitted in response to activating the control (113);
the controller (110) comprises a display screen (112) for displaying the control (113); and
the property (140) at least partially defines the control (113).

10. A system (100) comprising:
a device (120) being remotely controllable by means of a signal (130), the device (120) having a property (140) which at least partially defines how the device (120) is remotely controllable, the device (120) comprising
transmitting means (121) for transmitting the property (140), and
receiving means (122) for receiving the signal (130);
a controller (110) for remotely controlling the device (120) by generating and transmitting the signal (130), the controller (110) comprising further receiving means (111) for receiving the property (140), wherein the controller (110) for remotely controlling the device (120) by generating a signal (130) and transmitting the signal (130) to the device (120) is arranged to generate the signal (130) in dependence on the received property (140).

11. A method of remotely controlling a device (120) by means of a signal (130), the device (120) having a property (140) which at least partially defines how the device (120) is remotely controllable, the method comprising the steps of:
transmitting the property (140) of the device (120);
receiving the property (140); and
generating the signal (130) in dependence on the received property (140).

12. A signal for transmitting a property (140) of a remotely controllable device (120), the signal comprising the property (140), the property (140) at least partially defining how the device (120) is remotely controllable.

13. A signal (150) for initiating a transmission of a property (140) of a remotely controllable device (120), the property (140) at least partially defining how the device (120) is remotely controllable.
